(19) United States
(12) Patent Application Publication
(10) Pub. No.: US 2014/0257947 A1
(43) Pub. Date: Sep. 11, 2014

(54) Integrated Content Provider-Distributor Network

(71) Applicant: Live365, Inc., Foster City, CA (US)

(72) Inventors: Nikita Fonarev, Novato, CA (US); Kevin LIAO, Foster City, CA (US)

(73) Assignee: LIVE365, INC., Foster City, CA (US)

(21) Appl. No.: 14/194,418

(22) Filed: Feb. 28, 2014

Related U.S. Application Data
(60) Provisional application No. 61/775,583, filed on Mar. 9, 2013.

(51) Int. Cl. G06Q 30/06; G06Q 30/02

(52) U.S. Cl. CPC G06Q 30/0601; G06Q 30/0241
USPC 705/14.4; 705/26.1

(57) ABSTRACT

A method and system for providing a digital platform including interactive tools to a plurality of content providers to enable broadcasting via digital streaming by the content providers, side-loading and cross selling between content providers, connecting one or more content providers with each other and with selected content consumers are disclosed.

### CROSS REFERENCE TO RELATED APPLICATIONS

This application claims the benefit of U.S. Provisional Patent Application No. 61/775,583 filed Mar. 9, 2013, entitled, “Integrated Content Provider-Distributor Network,” by Fonarev et al., and which is hereby incorporated by reference in its entirety.

### TECHNICAL FIELD

The present invention is directed to electronic communications, and more specifically to aspects of digital media content acquisition, curation, creation, promotion, distribution, and delivery technology.

### BRIEF DESCRIPTION OF THE DRAWINGS

FIG. 1 is a high-level diagram showing aspects of a discrete content provider-distributor network, according to certain embodiments.

FIG. 2 is a high-level diagram showing aspects of a discrete content provider-distributor network in the music industry, according to certain embodiments.

FIG. 3 is high-level drawing that illustrates the interactivity between stations using certain embodiments of the computer-implemented platform.

FIG. 4 illustrates sample content consumer interfaces associated with the locker application and the computer-implemented platform, according to certain embodiments.

FIG. 5 illustrates sample station holder interfaces associated with the locker application and the computer-implemented platform, according to certain embodiments.

FIG. 6 illustrates more sample station holder interfaces associated with the locker application and the computer-implemented platform, according to certain embodiments.

### DETAILED DESCRIPTION

Methods, systems, user interfaces, and other aspects of the invention are described. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

According to certain embodiments, a computer implemented platform is created to support and enhance networking relationships in any multimedia communications industry involving a discrete content provider-distributor network or networks. A “discrete content provider-distributor network” is any system of connections involving one or more parties that may at times provide multimedia content and/or may at times distribute such multimedia content to consumers. The invention integrates a discrete content provider-distributor network by bringing together separate parties in the form of a community and allowing more efficient, more direct, more widespread, and more enhanced connections, communications, interactions, and transactions by and among them.

The multimedia communications industry as referenced herein includes but is not limited to the music industry and its associated discrete networks of multimedia content providers, distributors, and consumers.

According to certain embodiments, such a computer-implemented platform may be a digital platform that includes one or more computer networks such as internets, intranets, extranets or some combination thereof. Such a digital platform may be cloud-based. According to certain other embodiments, the computer implemented platform may be operated within a private network. The network may be a distributed network.

Such a computer-implemented platform also includes software applications, computer servers, computer databases, storage devices, and user interfaces to allow the relevant players in the multimedia communications industry to: 1) network, 2) promote products and services, 3) monetize products and services, 4) engage with each other, 5) engage with each other's followers and/or fans, and 6) broadcast streaming multimedia content (including but not limited to content consumer listening/watching to streaming audio/media content and downloading such content).

According to certain embodiments, categories of users of the digital platform described herein include but are not limited to: 1) artists, 2) venues (including but not limited to owners and managers of such venues), 3) events (including but not limited to promoters, organizers and creators of such events), 4) bloggers, and 5) college radio broadcasters. User categories are herein referred to as user “channels.”

As a non-limiting example, the channels that form a discrete music industry content provider-distributor network include artists, venues, events, bloggers and college radio broadcasters. Artists are the creators of original content (multimedia or single media) that can be distributed, such as through a network. Venue owners manage physical establishments that allow artists to showcase the artist's work (music, music videos etc.) to audiences, followers, and fans. Event promoters or entertainment promoters market and create interest in live events such as concerts, festivals, etc. For example, event promoters work with venues to organize events that range from small parties in local venues to multi-day festivals in big open spaces. Bloggers write artist reviews to showcase artists, artist's work, music bands, DJs, sound tracks, music videos, etc. College radio broadcasters are stations that are useful for discovery of primarily up-and-coming artists and “indie” bands (i.e., independent music or bands that are generally not affiliated with a major record label). Thus, college radio broadcaster stations generally tend to provide a distribution system for new artists.

According to certain embodiments, each of the aforementioned categories of users, or channels, can use the computer-implemented platform described herein to create one or more “stations” to broadcast streaming multimedia or single media content to consumers.

According to certain embodiments, multimedia content can include sound, or image, or animation, or video, or text, or graphics, or any combination thereof. Thus, the embodiments include the use of single media content such as only audio, or only video or only text, or only graphics or only image. Further, at least a subset of stations or channels is not restricted to broadcasting only one particular form of content. For example, a particular station may broadcast multimedia content some of the time and may broadcast single media content at other times. For convenience, the term “content” as used herein can mean multimedia content or single media content.

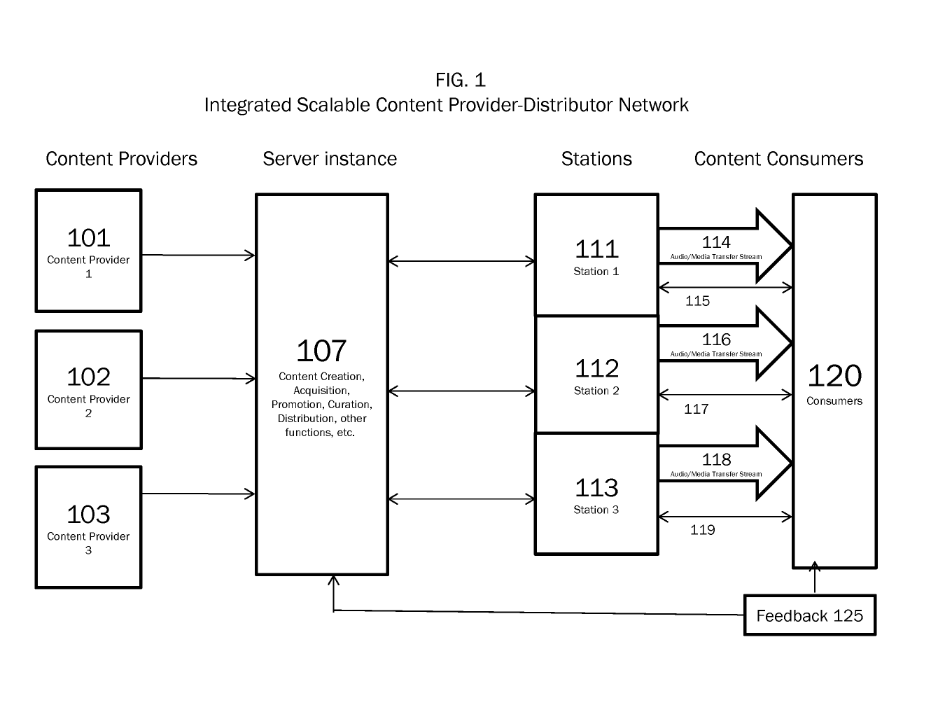

A station can integrate and program for broadcasting its own content or content created by other stations, depending on the access rights attached to the content as described in greater detail with reference to FIGS. 1-6.

According to certain embodiments, each of the aforementioned categories of users can use the computer-implemented platform described herein for 1) creating broadcasting stations, 2) curating multimedia content, 3) searching multimedia content, 4) creating multimedia content, 5) promoting multimedia content, 6) acquiring multimedia content, 7) distributing multimedia content amongst broadcasting stations, 8) discovering multimedia content, 9) streaming multimedia content to consumers, 10) interacting amongst broadcasting stations and consumers, and 11) monetizing multi or single-media streams. The categories of users can also use the platform to monetize products and services.

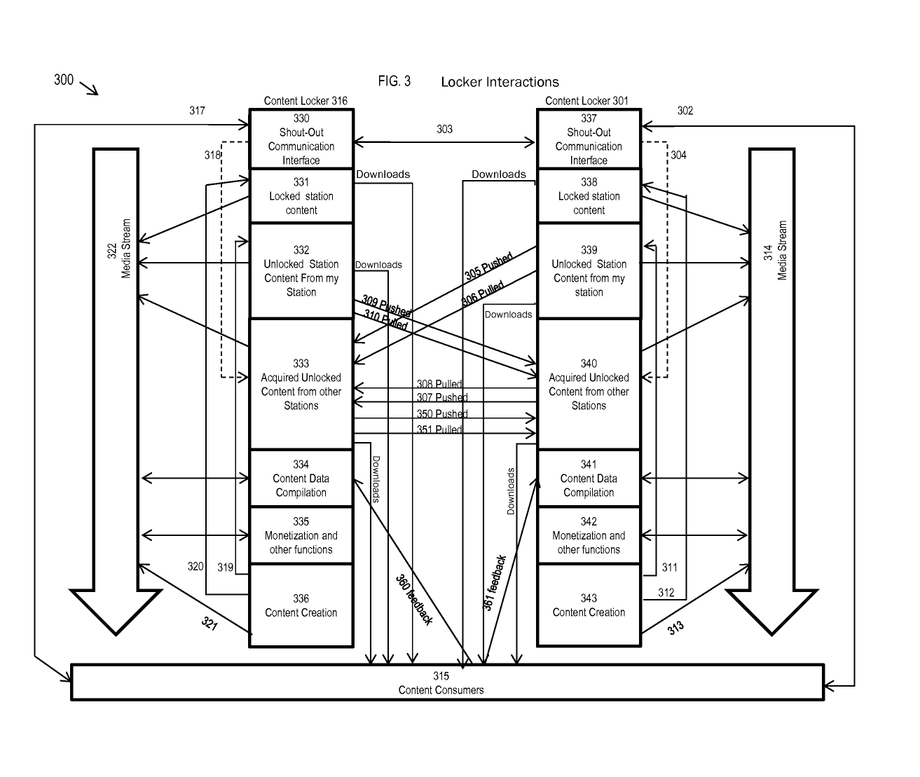

According to certain embodiments, each “station” is associated with a computer-implemented content “locker” that is described in greater detail with reference to FIG. 3. The content locker allows a station to perform the functions mentioned above (curating, searching, creating, distributing, discovering, etc.) through a user interface/application interface by using a mobile device or a computer (client devices).

FIG. 1 is a high-level diagram showing aspects of a discrete content provider-distributor network, according to certain embodiments. FIG. 1 shows three content providers (101, 102, 103). The embodiments are not limited to the number of content providers shown in FIG. 1. For example, a set of content providers can include all or any of the categories of users of the computer-implemented platform including but not limited to the aforementioned music industry content provider-distributor network: 1) artists, 2) venues, 3) events, 4) bloggers, and 5) college radio broadcasters. Further, there may be multiple content providers from a given user category (“channel”). For example, while only one content provider 1 101 is shown, there may be a plurality of content promoters of the same category as content provider 1. Similarly, there may be a plurality of content providers in the same categories as content provider 2 102 and content provider 3 103 etc.

FIG. 1 also shows a server instance 107, and stations (111, 112, 113) such as content station 1 111, content station 2 112, and content station 3 113. While only 3 stations are shown, there may be many more stations because the number of stations corresponds to the number of content providers from any of the user categories or channels mentioned above. Further, it is to be understood that there may be multiple server instances that are associated with one or more servers in the computer-implemented platform of the embodiments. Each station uses server instance 107 to create content streams (114, 116, 118) for streaming and/or transferring content to content consumers 120. Stations (111, 112, 113) can also use server instance 107 to perform one or more of the following functions: 1) curate content, 2) search content, 3) create content, 4) promote content, 5) acquire content, 6) distribute content amongst broadcasting stations, 7) discover content, 8) allow consumers to download content, and 9) monetize products and services. Content consumers 120 may provide feedback information 125. Further, stations may create customized messages with any content (audio or video or image or graphics or text, either alone or any combination thereof) desired by the station, known as a “broadcaster message.” A broadcaster message may then be sent to server instance for processing and thereby inserted directly into content streams (114, 116, 118) for instantaneous, near-instantaneous, or other time interval communication of the broadcaster message to one or more content consumers. Similarly, content consumers can create “consumer messages” such as messages (115, 117, 119) for sending to the stations. Consumer messages can be customized messages with any content (audio or video or image or graphics or text, either alone or any combination thereof). The initial message is also referred to as a “shout out” and a reply message is also referred to as a “shout back.”

Such broadcaster messages and consumer messages are described in provisional application entitled “Multi-Level Media Communications Content and Message Delivery and Response” by Kevin Liao et al., and having Application Ser. No. 61/757,211, and which is incorporated by reference herein in its entirety.

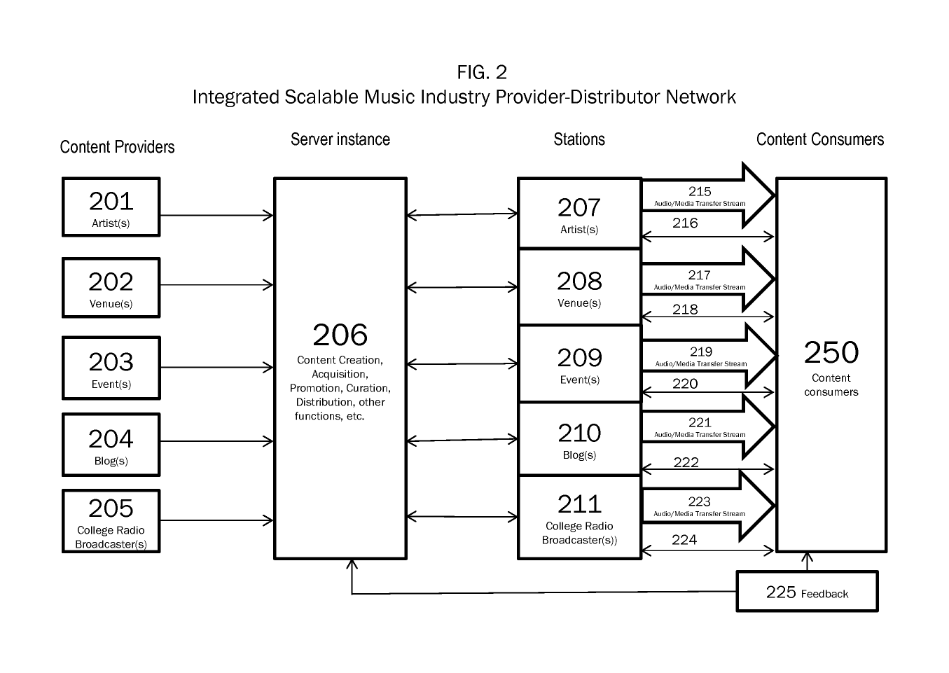

FIG. 2 is a high-level diagram showing aspects of a discrete multimedia content provider-distributor network in the music industry, according to certain embodiments. As described in the example above, in a discrete music industry provider-distributor network, Artists create original content that can be distributed, such as through a network; Venue owners and managers showcase artist work at physical sites; Events market and create interest in live events; Bloggers write artist reviews; and College radio broadcasters provide a distribution network for new artists. FIG. 2 shows as content providers (201, 202, 203, 204, 205) artists 201, venues 202, events 203, bloggers 204 and college radio broadcasters 205. The embodiments are not limited to the content providers shown in FIG. 2. There may be multiple content providers from a given user category (user channel). For example, while only one event 203 is shown, there may be a plurality of events. Similarly, there may be a plurality of venues, bloggers, and college radio broadcasters.

FIG. 2 also shows a server instance 206, and stations (207, 208, 209, 210, 211) such as artist station 207, venue station 208, event station 209, blogger station 210, and college radio broadcaster station 211. Although five (5) channels are shown in FIG. 2, there may be many more stations because the number of stations corresponds to the number of content providers from any of the channel categories mentioned above. Further, it is to be understood that there may be multiple server instances that are associated with one or more servers in the computer-implemented platform of the embodiments. Each station uses server instance 206 to create and manage content streams (215, 217, 219, 221, 223) for streaming to content consumers 250. Stations (207, 208, 209, 210, 211) can also use server instance 206 to perform one or more of the following functions: 1) curate content, 2) search content, 3) create content, 4) promote content, 5) acquire content, 6) distribute content amongst broadcasting stations, 7) discover content, and 8) monetize products and services. Content consumers 250 may provide feedback information 225. Further, stations or content consumers may create customized messages with any content (audio or video or image or graphics or text, either alone or any combination thereof) desired, known as a “shout out” message. The shout out message may then be sent to the server instance for processing and thereby inserted directly into content streams (215, 217, 219, 221, 223) for instantaneous, near-instantaneous, or other time interval communication of the shout out message to one or more stations (i.e., broadcasters) and/or content consumers. Similarly, content consumers and stations can create “shout back” messages, such as messages (216, 218, 220, 222, 224) for sending back in reply to the shout out message. Shout back messages can be customized messages with any content (audio or video or image or graphics or text, either alone or any combination thereof).

FIG. 3 is a high-level drawing that illustrates the interactivity between stations using certain embodiments of the computer-implemented platform. Such interactivity includes interactivity amongst stations as well as interactivity between and among stations and content consumers. Content consumers can also interact with other content consumers. The computer-implemented functions and features described with reference to FIG. 3 are herein referred to as the “locker application.” Some or all of the functions and features of the locker application are optional.

For ease of explanation, FIG. 3 is described herein with reference to the music industry content provider-distributor network described above. However, as previously explained, the computer implemented platform is created to support and enhance networking relationships in any multimedia communications industry involving discrete content provider-distributor networks. FIG. 3 shows content lockers (301, 316) in network 300. Content lockers are used in the curation and distribution of content by stations through a user interface to access the locker application. Each locker is associated with a station as previously described. Stations in network 300, by using content lockers (301, 316), create multimedia content streams (314, 322) that are streamed to content consumers 315. Only two lockers are shown in FIG. 3 for ease of description. It is to be understood that the embodiments are scalable to accommodate a multiplicity of lockers corresponding to a multiplicity of stations. As previously explained according to certain embodiments, there may be numerous 1) artist stations, 2) venue stations, 3) event promoter stations, 4) blogger stations, and 5) college radio broadcaster stations

According to certain embodiments, a given content locker includes but is not limited to a shout-out communication interface (330, 337), locked station content module (331, 338), unlocked station content from “my station” module (332, 339), acquired unlocked content acquired from “other stations” module (333, 340), content data compilation module (334, 341), monetization module (335, 342), and content creation module (336, 343). The modules represent software/hardware/middleware application logic rather than actual modules.

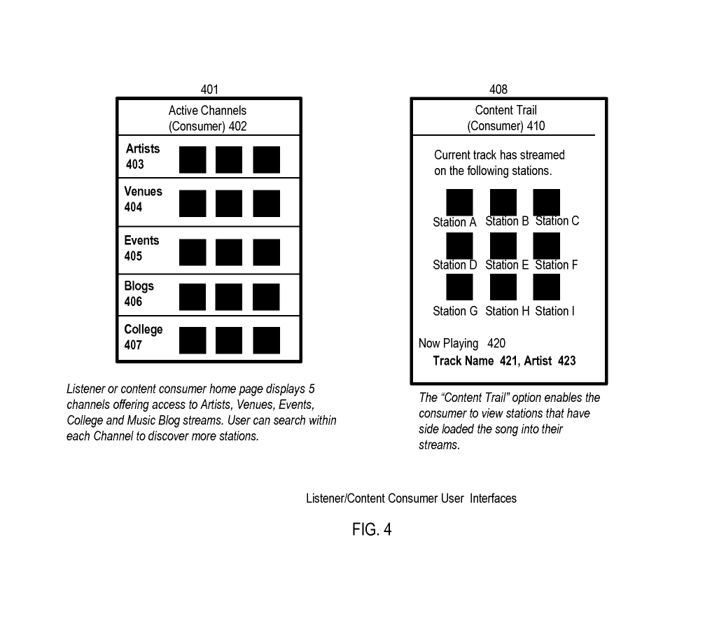

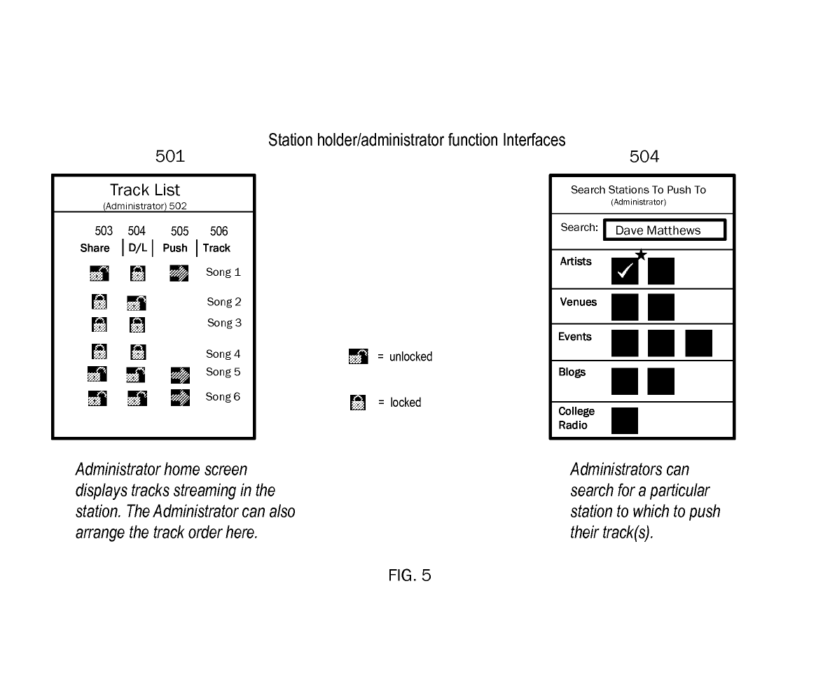

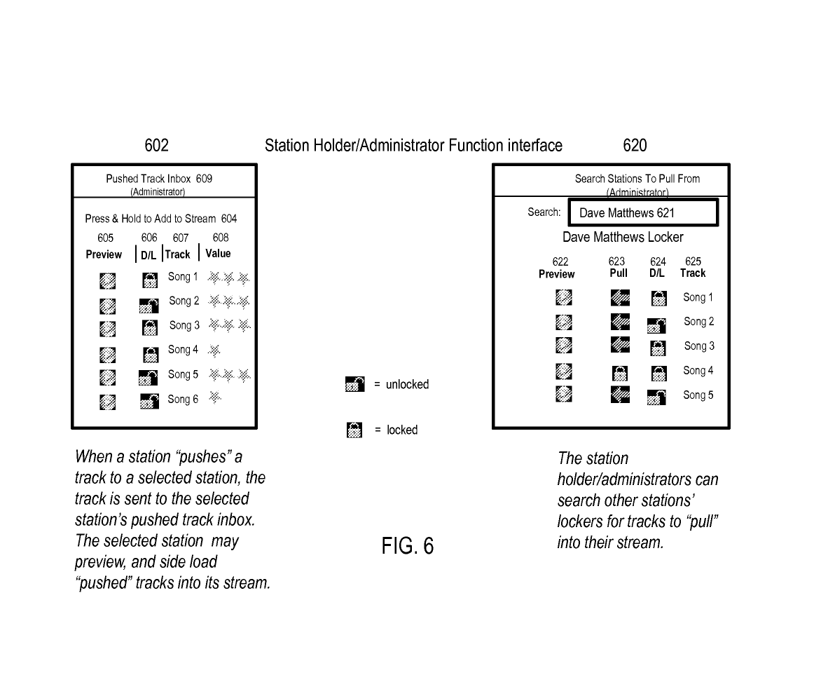

The station holder (station “Administrator”) can upload to the “locked station content” module (331, 338) content to which the station owner owns proprietary rights or has an obligation to preserve someone else's proprietary rights (e.g., royalty-bearing content). For example, the station holder can upload song tracks or music video or other content that the station holder does not want to share with other stations via “side-loading” and does not want others to download such content (e.g., the holder has “locked” such content). However, the station holder can include such content for creating media streams (314, 322) for streaming to content consumers 315. Side-loading involves “pulling” or “pushing” content from or to other stations and is described in greater detail herein with reference to FIG. 4, FIG. 5 and FIG. 6. A given station holder can upload to the “unlocked station content from my station” module (332, 339) content that the station holder owns but would like to share with other stations by “pushing” (305, 309) or “pulling” (306, 310) and with content consumers. For example, the station holder can manipulate the access rights of the song tracks or music video or other content such that these contents can be side-loaded by other stations and/or downloaded by content consumers. Also, the station holder can include such content from the module (332, 339) for creating media streams (314, 322) for streaming to content consumers 315. The station holder can also upload to the “acquired unlocked content from other stations” module (333, 340) content that was “pushed” (307, 350) or “pulled” (308, 351) from other stations. The access rights to such content are such that it can be shared between stations and/or downloaded by content consumers. Also, the station holder can include such content from the module (333, 340) for creating media streams (314, 322) for streaming to content consumers 315.

To further explain by way of example, in certain embodiments, a song track that is authorized for side-loading or downloading in one station can be accessed by content consumers (e.g., listeners) of other stations for both listening and downloading. Further, any station holder and any listener (content consumer) may trace the path of each item of side-loaded content in the network of stations 300 through a user interface described in greater detail with reference to FIG. 4-FIG. 6 herein.

A station or a content consumer (listener) can also create and send shout-outs (302, 317) and send shout-backs (302, 317) to stations by using the communication interface (330, 337). Further, a station holder has the option of sharing the shout-out/shout-back content with other stations by uploading (318, 304) such content to module (333, 340).

Thus, a station holder can create interesting media streams for broadcasting by selectively integrating content from all or a subset of the modules in the locker.

The locker application can also be used to manage a station. For example, a station Q can use the content data compilation module (334, 341) to see statistical information such as but not limited to: 1) the number of stations that have side-loaded content from station Q, 2) how many songs or other content have been downloaded, 3) consumer feedback (360, 361), 4) consumer ratings of the station, 5) consumer interaction, 6) proportion of locked content to unlocked content at the station, 7) consumer ratings of content, 8) donations from consumers or other stations, etc. According to certain embodiments, some of the information from content data compilation module (334, 341) may be used for creating media streams (314, 322) for streaming to content consumers 315. According to certain embodiments, a station can be associated with a “value” or rating based on but not limited to consumer feedback and/or ratings, content and station usage information, and information revealing various other aspects of the station's interactions through the integrated provider-distributor network such as content acquired, promoted, distributed, etc. According to certain embodiments, the higher the “value” of a station, the higher it ranks in search results presented to a user performing a search for content, or for stations from which to pull content, or to which to push content, for example.

According to certain embodiments, the locker application aids in collecting data for each station and assigns a “value” with several practical applications for both in-app and out-of-app activities. For example, a highly valued station can appear in front of listeners on the station's interface more frequently; be featured more prominently to enable other stations to choose which pushed tracks to accept to a station; while also being a target for businesses and other parties looking to do business with the station holder.

The locker application can also be used to monetize products and services. A station can use the monetization module (335, 342) to access monetization opportunities including but not limited to: 1) fee payments, (e.g., subscription fees, content download fees, broadcast fees, station fees, etc.), 2) brand sponsorship access, 3) merchandizing, 4) event ticketing, and 5) other monetization methods.

An example of a commercial use involves the multimedia communications industry. A station can determine which content and at what price the content can be accessed by a consumer. There can be a price per item of content or for a stream of various content. For example, station X can set a price for accessing to a stream of content associated with station X using various options. Options may include but are not limited to: 1) a “name-your-price” access rate, 2) a specified “fixed-price” access rate, and 3) a specified “minimum-price” access rate. Similarly, each song track or content unit that is enabled for download or is created using the “content creation” module (336, 343) described below may be designated by the station for access by a listener (content consumer) on “name-your-price,” “fixed-price,” or “minimum price” terms.

According to certain embodiments, brand sponsorship access can provide monetization opportunities. For example, advertisers may want to target their outreach (e.g., marketing) efforts to reach a calculable number of consumers of specific stations for a specified period of time. In the music industry, the monetization module (335, 342) and other modules can provide a customized and automated platform to allow advertisers (e.g., businesses) to purchase for such consumers, a right to access certain stations for a limited time period. Such access may be referred to as a “pass.”

The “content creation” module (336, 343) enables stations to create original content by allowing “in-app” (using the platform described herein) recordings. This can be done through the client device microphone or any input ports connected to a mixer. This content can be distributed live (321, 313) to content consumers (e.g., followers or fans) or stored (320, 319, 312, 311) in the lockers and can also be monetized, including by using methods such as subscriptions and downloads.

FIG. 4 illustrates sample content consumer interfaces associated with the locker application and the computer-implemented platform, according to certain embodiments.

FIG. 4 shows a home page display 401 of a content consumer that is using the locker application and the computer-implemented platform. Home page display 401 shows active stations in each channel 402. For example, the active stations may be displayed in categories such as but not limited to artists stations 403, venues stations 404, events stations 405, blogs stations 406, and college broadcaster stations 407. A content consumer can use the interface to search and discover stations in each station category. According to certain embodiments, the home page 401 is populated based on but not limited to: 1) the content consumer's geographical location, 2) the content consumer's content consumption history, 3) the content consumer's preference settings, 4) payment for stations to be featured on a prime display location on the content consumer's home page, 5) ratings values of the displayed stations, etc.

According to certain embodiments, the locker application provides an interactive user interface to content consumer to perform searches. To explain in the context of the music industry content provider-distributor network example described above, integrated into the search results is both music and event data. All the categories of stations/channels will produce a search result targeted to each specific search. For example, an artist search may display to the listener the original artist station; followed by artist stations that have “side-loaded”content from the original artist; venues (stations) where the artist is scheduled to perform or has performed; venue stations that have “side-loaded” content from the original artist; events (stations) where the artist is scheduled to perform or has performed; Blogs, and college broadcaster radio stations that have “side-loaded” content from the original artist.

FIG. 4 also shows a sample content trail interface 408. According to certain embodiments, the content consumer (410) can interact with the content trail interface 408 to allow the user to see, as an example, what content is currently streaming (420), including name of the content 421 and the artist 423 associated with the content. The content trail interface 408 can also show the stations (stations A-F, etc.) that have side-loaded the content that is currently streaming. The content consumer may use the interface to discover more stations, if any.

FIG. 5 illustrates sample station holder (e.g., the station Administrator) interfaces associated with the locker application and the computer-implemented platform, according to certain embodiments.

FIG. 5 shows a sample home page 501 for a station. Home page 501 includes a content list display 502. For example, the content list displays the content units (506) for streaming by the station (e.g., song 1-song 6). Each content unit or stream is associated with icons to indicate if the content can be shared/side-loaded (503), and/or can be downloaded (504). The station holder can use the interface to see other stations and associated content available for streaming, if any

FIG. 5 also shows a sample search screen 504. A station holder can use the search screen to search for stations to which content can be pushed (505). For example, the search screen allows searches for artist stations, venue stations, event stations, blog stations, college broadcaster radio stations, etc. The station holder can use the interface to discover more stations, if any.

FIG. 6 illustrates more sample station holder interfaces associated with the locker application and the computer-implemented platform, according to certain embodiments.

FIG. 6 shows a “pushed” content sample display screen 602. According to certain embodiments, when a station pushes a track or other content to a selected station, the pushed track/content is sent to the selected station's pushed content inbox 609. The sample “pushed” content inbox 609 interactive display screen 602 allows a station holder to select and add (604) content to the station's stream. The station holder can also preview (605) pushed content, view if pushed content is available for download by listener (606), if unlocked for download, see the name (607) of the pushed content, and see the value (608) of the pushed content, for example. The station holder can use the interface to see more pushed content, if any.

FIG. 6 also shows a sample search screen 620. A station holder can use search box 621 to search other stations' lockers for content that the station holder would like to pull, according to certain embodiments. Sample search screen 620 displays the search results (625) of a search for desired content (songs 1-5). Also, the station holder can also preview (622) content, see which content can be pulled by other stations (623), and which content can be downloaded by listeners (624). The station holder can use the interface to discover more desired content, if any.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

We claim:

1. A method comprising:
providing a digital platform including interactive tools to a plurality of content providers to enable:
broadcasting, via digital streaming, a first custom digital content by a first content provider of the plurality of content providers, the first custom digital content including first live content, and first programmed content;
broadcasting, via digital streaming, a second custom digital content by a second content provider of the plurality of to content providers, the second custom digital content including second live content, and second programmed content;
pulling, by the first content provider, digital content from one or more content providers of the plurality of content providers to form first acquired digital content;
pushing, by the first content provider, a subset of the first custom digital content and or a subset of the first acquired digital content to one or more content providers of the plurality of content providers;
pulling, by the second content provider, digital content from one or more content providers of the plurality of content providers to form second acquired digital content;
pushing, by the second content provider, a subset of the second custom digital content and or a subset of the second acquired digital content to one or more content providers of the plurality of content providers:
cross selling amongst the plurality of content providers by revenue sharing; and
connecting one or more content providers of the plurality of content providers with each other and with selected content consumers.

2. The method of claim 1, further comprising including any four from:
artists, venues, event promoters, bloggers, and college radio broadcasters as the plurality of content providers.

3. The method of claim 1, further comprising enabling creation of one or more digital broadcast stations associated with a content provider of the plurality of content providers.

4. The method of claim 1, further comprising enabling one or more of:
merchandizing, event ticketing, paying fees for accessing streaming content, paying fees for side-loading content, paying fees for downloading content, and tipping by content consumers.

5. The method of claim 1, further comprising enabling brand sponsorship by any one of: allowing business sponsors to purchase, for content consumers, access to selected content associated with the digital platform, and offering content providers a set of sponsorship opportunities from which to select.

6. The method of claim 1, further comprising including audio, and or video, and or other media, and or multimedia content as the first custom digital content, the second custom digital content, the first acquired digital content, and the second acquired digital content.

7. The method of claim 1, further comprising including shout-backs from content consumers as the first custom digital content, the second custom digital content, the first acquired digital content, and the second acquired digital content.

8. The method of claim 1, further comprising enabling discovery, by a content consumer, of digital content and digital broadcast stations associated with one or more content providers of the plurality of content providers.

9. The method of claim 8, further comprising enabling discovery based on one or more of: the content consumer's geographical location, the content consumer's content consumption history, the content consumer's preferences, content trail of content side-loaded by content providers, payment for digital broadcast stations to be featured on a prime display location on the content consumer's home page, ratings values of displayed digital broadcast stations.

10. The method of claim 1, further comprising providing search interface to enable search for target digital content, and digital broadcast stations associated with any of: artists, venues, event promoters, bloggers, and college radio broadcasters.

11. The method of claim 10, further comprising including as search results digital broadcast stations that broadcasted the target digital content or have side-loaded the target digital content.

12. The method of claim 10, further comprising including as search results digital broadcast stations where an artist, associated with the target digital content, has performed or is scheduled to perform.

13. The method of claim 1, further comprising providing a content trail interface to enable a content consumer to view a set of attributes associated with a currently streaming digital content.

14. The method of claim 1, further comprising providing an content trail interface to enable a content consumer to view a set of digital broadcast stations that have side-loaded a currently streaming digital content.

15. The method of claim 1, further comprising enabling integrated branding by brand sponsors.

16. The method of claim 1, further comprising performing data analytics on the content providers, the digital content and associated financial information, distribution, consumption and monetization.

17. The method of claim 1, further comprising enabling discovery of events associated with one or more content providers based on date and consumer's geographical location.

18. The method of claim 1, further comprising identifying a third content provider from the plurality of content providers for special services by using statistical information including one or more of: number of stations that have side-loaded content from the third content provider's station, quantity of content downloaded from the third content provider's station, consumer feedback associated with the third content provider's station, consumer ratings of the third content provider's station, consumer interaction with the third content provider's station, proportion of locked content to unlocked content at the third content provider's station, consumer ratings of content associated with the third content provider's station, and contributions from consumers or content providers to the third content provider.
